(19) United States
(12) Patent Application Publication
(10) Pub. No.: US 2015/0234953 A1
(43) Pub. Date: Aug. 20, 2015

(54) METHOD FOR CALCULATING ENGINE CHARACTERISTIC VARIABLES, DATA PROCESSING SYSTEM AND COMPUTER PROGRAM PRODUCT

(71) Applicant: MTU FRIEDRICHSHAFEN GMBH, Friedrichshafen (DE)

(72) Inventors: Ralf Speetzen, Friedrichshafen (DE); Yvan Bronner, Friedrichshafen (DE)

(21) Appl. No.: 14/428,562

(22) PCT Filed: Sep. 6, 2013
(86) PCT No.: PCT/EP2013/002685

§ 371 Date: Mar. 16, 2015

(30) Foreign Application Priority Data
Sep. 14, 2012 (DE) 10 2012 018 617.7

(51) Int. Cl. G06F 17/50; G06F 17/10

(52) U.S. Cl. CPC G06F 17/5009; G06F 17/10

(57) ABSTRACT

A method for calculating engine characteristic variables of an internal combustion engine having the following steps: determination of an alternative injection profile in a first curve form which is described by interpolation points, by the interpolation points being calculated from at least one first engine characteristic variable; and determination of an alternative combustion profile in a second curve form which is described by interpolation points, by at least one interpolation point being calculated from the alternative injection profile and at least one second engine characteristic variable.

The invention concerns a method for computing engine characteristics of an internal combustion engine in accordance with Claim 1, a data processing system in accordance with the introductory clause of Claim 12, and a computer program product in accordance with Claim 13.

Methods of the type addressed here are well known. In these methods, at least one engine characteristic of an internal combustion engine is computed with the aid of a combustion model, which allows the zero-dimensional computation (OD) of the energy release rate, namely, the so-called combustion profile of the internal combustion engine. In this regard, the term “zero-dimensional” indicates that for a given cylinder under consideration, an integral combustion profile is computed purely as a function of time. Accordingly, no consideration is given to the combustion profile as a function of the location within the combustion chamber of a cylinder. In this connection, it is possible to use the combustion profile itself as the engine characteristic. However, it is also possible to use the combustion profile to compute other engine characteristics, such as pollutant emissions, a mean indicated pressure, or a peak cylinder pressure. The computation of the one or more engine characteristics can then be used for the simulation, control and/or regulation of the internal combustion engine. Combustion models are known which depend completely on measured data. In these models, it is necessary to acquire large amounts of measured data for each engine and for each application, and this requires a great deal of effort. With respect to an individual engine, measured data must be converted for different operating states, which involves considerable computational work and produces a great deal of uncertainty. Due just to the large number of data points involved, the computation of a combustion profile on the basis of this type of combustion model is complicated and memory intensive and requires high computing power. Alternatively, empirical combustion models can be used that comprise mathematical approaches for describing individual physical mechanisms and phenomena of combustion. However, here too it is necessary to determine a large number of model parameters and to convert or adapt them for different zones of an input-output map of an internal combustion engine and thus for different operating states. Combustion profiles based on these kinds of empirical combustion models are also typically computed with a large number of interpolation points, so that here again considerable memory capacity and computing power are needed.

German Patent Application DE 10 2007 034 340 A1 describes a method for determining an equivalent combustion profile, in which, to describe the combustion profile, including a so-called premixed zone and a diffusion-controlled zone of the combustion, two Vibe functions are superposed. This procedure is an example of the computation of a combustion profile on the basis of an empirical, mathematical/physical model, here namely, the Vibe function.

The article, “The Predetermination of the Combustion Profile of Diesel Engines with Direct Injection on the Basis of the Injection Profile” by Franz Chmela et al., MTZ 59 (1998), No. 7/8 describes a zero-dimensional approach to the computation of a combustion profile, in which an injection profile is incorporated in the computation to the extent that the kinetic energy of the injection jet is taken into consideration. This too is an example of the computation of a combustion profile on the basis of an empirical, mathematical/physical model.

In addition to the stated disadvantages of a complicated computation and the need for high memory capacity and computing power, the previously known approaches have the problem that direct relationships between the computed combustion profile or equivalent combustion profile and the engine characteristics incorporated in the modelling are difficult to recognize. Accordingly, it is not a simple matter to predict the changes that will occur in the equivalent combustion profile when a given engine characteristic is varied in a given way.

Therefore, the objective of the invention is to create a method for computing engine characteristics of an internal combustion engine which allows simplified computation of engine characteristics that is less memory intensive and requires less computing power, especially engine characteristics of an equivalent combustion profile, and which at the same time makes it easier to recognize relationships between the result of the computation and the engine characteristics that go into the computation. A further objective of the invention is to create a data processing system, especially an engine control unit that can perform the computation discussed here. A final objective of the invention is to create a computer program product that allows the desired computation to be performed.

The objective is achieved by a method with the steps given in Claim 1. The method of the invention for computing engine characteristics of an internal combustion engine involves the determination of an equivalent injection profile based on a first curve form described by interpolation points. These interpolation points are computed from at least one engine characteristic. An equivalent combustion profile, especially one that is zero-dimensional, is then determined, which is based on a second curve form described by interpolation points. In this regard, at least one of the interpolation points for the second curve form of the equivalent combustion profile is computed by using the equivalent injection profile and one or more second engine characteristics.

Accordingly, a relatively simple approach is chosen for the equivalent injection profile and for the equivalent combustion profile by using predetermined curve forms described by interpolation points, where the positions of the interpolation points can be quickly and easily computed. This results in a relatively simple relationship between the one or more first engine characteristics and the equivalent injection profile, so that variations in the equivalent injection profile that occur when the first engine characteristic changes can be easily predicted. The same applies to the equivalent combustion profile, because at least one of its interpolation points is computed with the use of the equivalent injection profile and an engine characteristic. In this connection, a relationship between the equivalent injection profile and the equivalent combustion profile is relatively easy to recognize, i.e., a change in the equivalent combustion profile is relatively easy to predict if a change in the equivalent injection profile is known. Both the equivalent injection profile and the equivalent combustion profile are described not by analytic functions nor for that matter completely by—possibly interpolated—measured data but rather by a predetermined first and second, respectively, curve form for which interpolation points are determined. Therefore, basically only the positions of the interpolation points is to be computed, with, in addition, possibly a few other parameters to be computed to more closely describe the curve form. All together, therefore, a parameterizable equivalent injection profile and a parameterizable equivalent combustion profile are computed, with it being necessary to compute only a relatively small number of values. The requirements for memory and computing power are thus small, and the computation is relatively simple. This makes it possible, for example, to save memory space, computing power and computing time in an engine control unit in which the method is implemented, so that these resources can be used elsewhere. Alternatively, the engine control unit can be equipped with a smaller amount of memory space or computing power, which lowers costs.

The relationships between the equivalent injection profile and the equivalent combustion profile can be physically modelled and determined by mathematical conversion rules, so that it is immediately possible to compute the equivalent combustion profile from the equivalent injection profile. If the method is carried out in an engine control unit, the engine characteristics used for the computation are already at least largely and preferably completely available in the engine control unit, because they are monitored or determined there. Thus, no additional effort is required to determine and/or compute necessary data.

The method is preferably carried out for a diesel engine, especially a diesel engine with direct injection. In this connection, a typical first curve form for the equivalent injection profile as well as a typical second curve form for the equivalent combustion profile are selected which are characteristic for diesel engines.

A preferred method is characterized by the fact that a trapezoidal shape is assumed for the equivalent injection profile, in which at most ten, preferably at most eight, more preferably still at most six, and especially preferably exactly four interpolation points are used to describe the first curve form. For the shape of the curve between the interpolation points, a predetermined functional plot is assumed, preferably a linear plot. Thus, if, in a preferred embodiment of the method, exactly four interpolation points are provided, between which straight line segments extend, a graphic representation of the equivalent injection profile shows the form of a trapezoid whose vertices are given by the four interpolation points. It is apparent that only the position of the four interpolation points must be computed in order completely to determine the equivalent injection profile. This means that very little computing power is needed and that the requirement for memory capacity is also very low. The trapezoidal form is typical for the injection profile, especially of a diesel engine, so that the actual injection profile can be described with sufficient accuracy by the equivalent injection profile.

Another preferred method is characterized by the fact that the equivalent combustion profile is described by at most twelve interpolation points, preferably at most ten, more preferably at most eight, and especially preferably exactly six interpolation points and by a predetermined functional plot between the interpolation points. The second curve form preferably follows a polygonal path followed by a hyperbola. This means that the first interpolation points, with the exception of the second-to-last and the last interpolation points, are connected by straight line segments, corresponding to a linear plot between the interpolation points. In this regard, the term “first interpolation points” designates the interpolation points with abscissa values rising from the lowest abscissa value, where the interpolation point with the second-highest abscissa value and the interpolation point with the highest abscissa value are not connected with each other by a straight line segment. Instead, these last two interpolation points are preferably connected with each other by a hyperbola. Thus, in a preferred embodiment, if exactly six interpolation points are provided for the equivalent combustion profile, then the first five interpolation points, starting from the interpolation point with the lowest abscissa value, are connected with each other by straight line segments, while the fifth and sixth interpolation points are connected with each other by a hyperbolic curve. This type of polygonal path with a hyperbola represents a curve form that is typical for the combustion profile of a diesel engine, so that this can be described with sufficient accuracy by the equivalent combustion profile. It is found that in this case it is only necessary to compute the positions of the interpolation points, and, in addition, a parameter for the path of the hyperbola is also computed. However, this is negligible with respect to the total amount of computing power used. All together, it is thus found that only small amounts of computing power and memory capacity are needed for computing the equivalent combustion profile.

Both with respect to the equivalent injection profile and with respect to the equivalent combustion profile, it is possible to replace straight line segments connecting different interpolation points by other functions, especially at least one weighted and/or rounded function, to obtain an even more accurate description of the actual injection profile and/or combustion profile. This results in only a slight increase in the requirements for computing power and memory capacity, because only a small number of additional parameters possibly need to be computed. A rounded function is preferably rounded especially in the vicinity of the interpolation points. This makes it possible to avoid discontinuities and thus undifferentiable regions of the equivalent injection profile and/or equivalent combustion profile.

A preferred method is characterized by the fact that the one or more first engine characteristics, with which the equivalent injection profile is determined, are selected from a group comprising an engine speed, an injection start, an injection time, an injected fuel quantity, a fuel temperature, a fuel density, an injection pressure, a cylinder internal pressure at the time of injection start, and a compression ratio in a given cylinder under consideration. In this regard, it is possible for more than one of the engine characteristics specified here to enter into the determination of the equivalent injection profile. In particular, it is also possible for all of the engine characteristics specified here to be used in the determination of the equivalent injection profile. If the method is carried out in an engine control unit, the specified characteristics are generally already available there, so that no further measures are needed for their determination.

Another preferred method is characterized by the fact that the one or more second engine characteristics used to determine the equivalent combustion profile are selected from a group comprising an ignition delay time, an opening time of an exhaust valve of a cylinder, a speed of the internal combustion engine, a charge motion within the cylinder, especially a spin, an exhaust gas return rate, a piston shape, and an injection parameter. An injection parameter that can be considered includes especially an engine characteristic selected from the group specified for the first engine characteristic, i.e., especially an injection start, an injection time, an injected fuel quantity, a fuel temperature, a fuel density, an injection pressure, a cylinder internal pressure at the time of injection start, and/or a compression ratio. Naturally, it is possible to use more than one of the characteristics specified here for the second engine characteristic. It is also possible for all of the engine characteristics specified here to be used in the determination of the equivalent combustion profile.

At least one interpolation point of the equivalent combustion profile is computed both on the basis of the one or more second engine characteristics and on the basis of the equivalent injection profile. Preferably, more than one interpolation point is computed on this basis. Of course, it is possible for at least one interpolation point of the equivalent combustion profile to be computed exclusively on the basis of one or more second engine characteristics without the use of the equivalent injection profile. It is also possible for at least one interpolation point of the equivalent combustion profile to be computed exclusively on the basis of the equivalent injection profile without the use of a second engine characteristic.

Another preferred method is characterized by the fact that at least one additional engine characteristic is computed from the equivalent combustion profile. Preferably, the equivalent combustion profile is used as the input variable for a working process computation, which is used to compute the one or more additional engine characteristics. In this regard, the term “additional engine characteristic” serves to linguistically distinguish the first and second engine characteristics that enter into the computation from the one or more additional engine characteristics that result from the computation. In this regard, it is by no means ruled out that the additional engine characteristic is a characteristic that has been incorporated in the computation as the first and/or second engine characteristic. It is thus perfectly possible, especially within the framework of automatic control, to compute the equivalent injection profile, the equivalent combustion profile, and, finally, an engine characteristic that was also used in the computation as an initial value, namely, as a first and/or second engine characteristic. In this connection, the value of the engine characteristic resulting from the computation typically differs from the value that went into the computation. In this way—again, especially within the framework of automatic control—an iterative computation of engine characteristics is also possible. It is thus clear that characteristics that have already been mentioned in connection with the first engine characteristic and the second engine characteristic can be computed as the additional engine characteristic.

In particular, however, it is also possible for the additional engine characteristic to be selected from a group that consists of a cumulative combustion profile, a cylinder pressure as a function of a crank angle, a mean indicated pressure, an emission value, an efficiency and an output of the internal combustion engine. In this connection, the cumulative combustion profile is defined as the integral over the combustion profile and gives the total quantity of heat released during combustion. An emission value consists especially of a pollutant emission value of the internal combustion engine, for example, an NOₓ concentration emitted by the engine.

The following is found: The equivalent combustion profile itself, which describes the quantity of heat released per degree of crank angle, can already be viewed, within the scope of the method, as an engine characteristic that characterizes the working process of the internal combustion engine. However, it is also possible to compute an additional engine characteristic of the internal combustion engine from the equivalent combustion profile. This can be utilized—for example, in a simulation of the internal combustion engine or, especially preferably, in an engine control unit—to predict engine characteristics, e.g., especially the efficiency, the output and/or the emissions of the internal combustion engine or changes in these characteristics upon changes in other boundary conditions. It is also possible to use the method for automatic control of the internal combustion engine or for automatic control of at least one engine characteristic of the internal combustion engine.

In this connection, a method which is preferred is one that is characterized by the fact that the equivalent combustion profile determined for an internal combustion engine and/or the one or more additional engine characteristics are used to control the operating state of the internal combustion engine. It is thus possible—especially in an engine control unit—to use the acquired engine characteristics to compute the equivalent combustion profile and/or the one or more additional engine characteristics, such that these can then be used to evaluate the operating state of the internal combustion engine and, especially on the basis of this evaluation, to control the operating state of the internal combustion engine as well.

If the method is carried out in an engine control unit, the equivalent combustion profile and/or the one or more additional engine characteristics can be determined or computed on the basis of the engine characteristics acquired in the engine and stored in the engine control unit. If, as a result, a nonoptimal combustion profile or a nonoptimal value of the additional engine characteristic is detected, or if a deviation from a set combustion profile or from a set value for the additional engine characteristic is determined, it is possible, on the basis of this detection or determination, systematically to control the operating state of the internal combustion engine. In this connection, at least one engine characteristic can be changed to counteract the detected problem.

A preferred method is characterized by the fact that a change in the equivalent combustion profile and/or the additional engine characteristic is computed for a change that could occur in a selected engine characteristic, such that the change predicted in this way is evaluated. It is thus possible experimentally to change a selected engine characteristic—preferably only virtually at first—and to apply the method to determine the effect of this change on the equivalent combustion profile and/or the additional engine characteristic. The evaluation of the change can be made especially by comparison with at least one set value or with a set combustion profile. On the basis of this evaluation, it is then possible in turn either to change the selected engine characteristic or to hold it constant—this time on a real basis in the internal combustion engine. In this way, it is possible to control the operating state of the internal combustion engine, for example, to increase its efficiency or output or to lower its emission values.

In this connection, another preferred method is one in which a plurality of changes in the selected engine characteristic are evaluated with respect to resulting changes in the equivalent combustion profile and/or the additional engine characteristic. In this regard, these changes are also preferably made only on a virtual basis at first in order to investigate the effects of such changes with the aid of the method. The selected engine characteristic can then either be changed or held constant on the basis of these evaluations—this time on a real basis in the internal combustion engine. In this regard, the changed value at which the effect on the equivalent combustion profile and/or on the additional engine characteristic was evaluated as the best under the given boundary conditions is preferably used for a change in the selected engine characteristic.

Alternatively or additionally, it is possible for the method to be carried out iteratively. In particular, it is possible to carry out a further investigation of changes in the previously changed selected engine characteristic in order to determine whether further positive changes in the equivalent combustion profile and/or the additional engine characteristic are to be expected. If this is the case, then the selected engine characteristic can be changed again. This can be continued until an extreme value is reached with respect to the evaluation of the changes in the equivalent combustion profile and/or the additional engine characteristic. In this way, it is possible, for example, to maximize the efficiency or output of the internal combustion engine or to minimize its emission values or fuel consumption.

Preferably, the method is used for automatic control of an engine characteristic during the operation of the internal combustion engine. In this connection, a set value for a selected engine characteristic is preferably preassigned, and an actual value of the selected engine characteristic is determined by the engine control unit and compared with the set value. The method can be used to predict, especially on the basis of the equivalent combustion profile, how a change in engine characteristics affects the control deviation of the selected engine characteristic. This allows efficient and systematic determination of possible changes in engine characteristics that lead to a rapid reduction of the control deviation.

Another preferred method is characterized by the fact that the equivalent injection profile and/or the equivalent combustion profile is determined for at least one operating point in the input-output map of an internal combustion engine. The equivalent combustion profile is then converted for additional operating points of the input-output map by means of the equivalent injection profile. It is thus possible to adjust the equivalent combustion profile and/or the equivalent injection profile with measured data at only a few locations of the input-output map, such that the equivalent combustion profile can be easily converted for other operating points in the input-output map on the basis of the equivalent injection profile.

To obtain the equivalent injection profile and the equivalent combustion profile, it is possible to proceed in the following way: First a combustion model based on measured data or an empirical, mathematical/physical combustion model is selected, which is not yet parameterized with respect to a specific internal combustion engine. The first curve form and the number of interpolation points necessary for its description are selected on the basis of this combustion model. In this connection, initially only the pure curve form and the number of interpolation points are determined without these already being parameterized. It is then possible to parameterize the equivalent injection profile with the aid of specific engine characteristics for a specific internal combustion engine, such that especially the positions of the interpolation points are determined. It is then possible to compute a parameterized equivalent combustion profile from this equivalent injection profile.

In this procedure, inaccuracies can arise, because initially the nonparameterized equivalent injection profile only roughly conforms to the nonparameterized model, whereupon only then is the equivalent combustion profile parameterized. Errors are thus possible both in the adaptation of the nonparameterized equivalent injection profile to the nonparameterized model and in the parameterization of the equivalent injection profile.

Alternatively, it is possible to proceed in the following way: Use is made of a completely parameterized combustion model for a specific internal combustion engine either on the basis of measured data or on the basis of an empirical, mathematical/physical model, to which is adapted an equivalent injection profile that conforms with respect to its first curve form and the number of interpolation points. If in this procedure the interpolation points are fitted exactly to the parameterized model, parameterization of the equivalent injection profile is obtained at the same time. Accordingly, in this procedure, parameterization errors and adaptation errors do not accumulate, because an adaptation to the already parameterized model occurs only once. A parameterized equivalent combustion profile can then be computed from the equivalent injection profile parameterized in this way. Although this procedure offers greater accuracy than the procedure described above, it is first necessary to set up a completely parameterized model, which involves considerable effort.

As repeatedly noted, the method is preferably carried out in an engine control unit. In this regard, it is possible especially to control the operating state and/or automatically control the internal combustion engine. It is also possible to utilize the method to make available to the driver information about the internal combustion engine or its combustion behavior. This possibility can also be exploited if the method is carried out in an engine control unit on an engine test stand, where valuable information that is possibly not immediately available elsewhere is made available to a workman monitoring a test run.

The second objective of the invention is achieved by creating a data processing system with the features of Claim 12. In this regard, the data processing system is preferably realized as an engine control unit. It is designed in such a way that it can be used to compute engine characteristics. The data processing system is characterized by the fact that it is designed for carrying out a method according to any of Claims 1 to 11. The advantages specified above in connection with the method also apply here. In particular, a data processing system of this type can have less memory and/or computing power than data processing systems in which previously known methods for computing engine characteristics are implemented; or a data processing system with the same amount of memory and/or the same amount of computing power can perform additional tasks, for which additional memory space and/or additional computing power would otherwise be necessary. Ultimately, this shows as a weight or price advantage for the data processing system, especially for the engine control unit.

The final objective of the invention is achieved by creating a computer program product with the features of Claim 13. This comprises program code means that are stored on a computer-readable data carrier, which is realized especially as a microchip of an engine control unit, for carrying out a method according to any of Claims 1 to 11, if the program is carried out on a computer, especially on a computer of an engine control unit. The advantages mentioned above in connection with the method and with the data processing system also apply here.

The invention will now be described in greater detail with reference to the drawings.

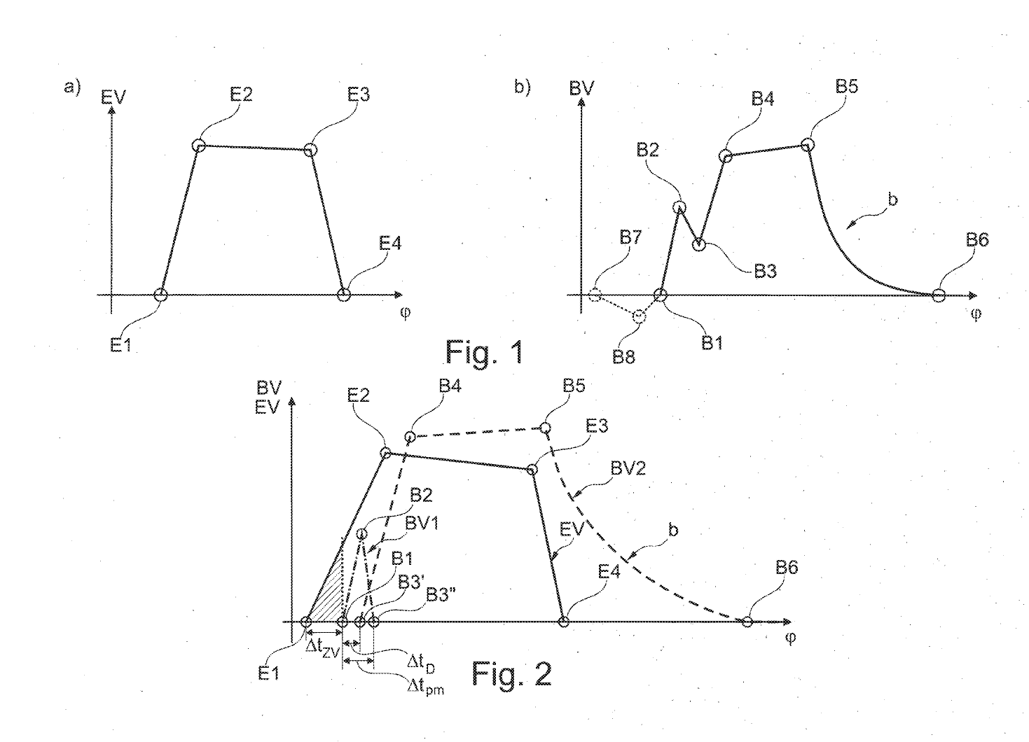

FIG. 1a) is a schematic graphic representation of an equivalent injection profile.

FIG. 1b) is a schematic graphic representation of an equivalent combustion profile.

FIG. 2 is a schematic graphic representation of the superposition of an equivalent injection profile with intermediate results for the equivalent combustion profile for a first combustion phase and a second combustion phase.

FIG. 1a) is a schematic graphic representation of an equivalent injection profile EV. The injection profile EV is plotted on the y-axis, typically in units of fuel mass injected per unit time, especially in kg/s. The crank angle φ of the internal combustion engine is plotted on the x-axis as a measure of time, which is typically given as °KW (crank angle). The injection profile EV has a basically trapezoidal curve form described by the four interpolation points E1, E2, E3, E4, which are connected with each other by straight line segments. In an alternative embodiment of the method, preferably at least one of the straight line segments connecting two interpolation points is replaced by a different function, preferably by a rounded and/or weighted function. It is especially preferred for the entire basically trapezoidal equivalent injection profile EV to be described by a profile weighted with a predetermined function. In particular, it is possible to weight at least one linear connection of the interpolation points with a predetermined function. A rounded function is preferably rounded especially in the vicinity of the interpolation points E1, E2, E3, E4 to avoid undifferentiable regions of the equivalent injection profile EV. The positions of the interpolation points E1, E2, E3, E4 are computed for a specific operating point of a specific internal combustion engine from one or more first engine characteristics. Especially the engine speed, the injection start, the injection time, the injected fuel quantity, the fuel temperature, the fuel density, the injection pressure, the cylinder internal pressure at the time of injection start, and/or the compression ratio of a given cylinder under consideration in the specific internal combustion engine is used in these computations. In this regard, the following is found: Variation of the injection pressure, especially the pressure in a pressure accumulator, a so-called rail, basically changes the slope of the flank between the interpolation points E1, E2. Variation of the injection time basically acts on the length of the plateau between the interpolation points E2, E3. The cylinder internal pressure at the time of injection start affects the height of the plateau between the interpolation points E2, E3, because the cylinder internal pressure represents, as it were, a pressure against which the injection must work. Of course, this effect is marginal. Finally, the temperature of the fuel and thus its density also act on the equivalent injection profile.

FIG. 1b) is a schematic graphic representation of an equivalent combustion profile BV computed on the basis of the equivalent injection profile shown in FIG. 1a), where the equivalent combustion profile BV and thus the quantity of heat released per degree of crank angle, preferably given in J/°KW, is plotted on the y-axis. The crank angle φ, preferably given in °KW, is again plotted on the x-axis. In this connection, it is found that, in a preferred embodiment of the method, the equivalent combustion profile is described by a polygonal path followed by a hyperbola, with preferably six interpolation points B1, B2, B3, B4, B5, B6 computed to describe the equivalent combustion profile. In this case, the interpolation points B1 to B5 are connected with each other by straight line segments, i.e., linear functions, whereas the two interpolation points with the highest abscissa values, in other words, the last two interpolation points B5, B6, are connected by a hyperbola, which is described by the additional parameter b.

In another embodiment of the method, it is possible to replace at least one of the straight lines connecting the interpolation points B1 to B5 by a weighted and/or rounded function or to weight at least one linear connection between two interpolation points with a predetermined function. In this regard, it is found here too that a rounded function is preferably rounded especially in the region of the interpolation points B1 to B5 in order to avoid undifferentiable regions of the equivalent combustion profile if possible. It is also possible to weight the course of the hyperbola between the interpolation points B5, B6 with a predetermined function. Finally, it is possible to describe the equivalent combustion profile BV completely by a predetermined, weighted and/or rounded function that passes through the interpolation points B1 to B6.

The first interpolation point B1 of the equivalent combustion profile BV is preferably computed as a function of an injection start and an ignition delay time Δt_{zv}. It is especially preferable for its position relative to the time of the injection start (specified in °KW) to be given by this plus the ignition delay time Δt_{zv} (likewise specified in °KW). In a preferred embodiment of the method, the ordinate value of the first interpolation point B1 can be set at zero, because at the ignition time designated by the first interpolation point B1, no quantity of heat has been released yet, at least in a first approximation.

The second interpolation point B2 and the third interpolation point B3 are preferably computed from the equivalent injection profile EV and the ignition delay time Δt_{zv}. The fourth and fifth interpolation points B4, B5 are preferably computed from the equivalent injection profile. This is discussed in greater detail below.

The sixth interpolation point B6 is preferably computed from an opening time of an exhaust valve of the given cylinder of the internal combustion engine. In a preferred embodiment of the method, the additional parameter b, which describes the hyperbola that connects the interpolation points B5, B6, is computed as a function of the speed and/or as a function of a charge motion in the given cylinder, especially a spin.

In a preferred, especially simple embodiment of the invention, precombustion effects in the given cylinder of the internal combustion engine are neglected, so that only the solid equivalent combustion profile BV shown in FIG. 1b) is considered, which is described by the interpolation points B1, B2, B3, B4, B5, B6.

In another, more complex embodiment of the method, it is possible also to consider precombustion effects by introducing the additional interpolation points B7, B8, which are located at smaller abscissa values than the first interpolation point B1. These interpolation points B7, B8 are shown as broken circles and are connected with each other and with the first interpolation point B1 by broken straight line segments.

FIG. 2 is a schematic graphic representation of the superposition of the equivalent injection profile EV with two combustion profiles BV that appear as intermediate steps in the computation of the equivalent combustion profile according to FIG. 1b). The computation of the interpolation points of the equivalent combustion profile from the equivalent injection profile will be explained in greater detail with reference to FIG. 2. Elements that are the same or functionally equivalent are provided with the same reference numbers, so that the preceding description also applies to these elements.

To compute the equivalent combustion profile BV from the equivalent injection profile EV, it is assumed that combustion in the cylinder comprises essentially two phases, which overlap. In a first phase, so-called premixed combustion takes place, in which the ignition delay time Δt_{zv} is followed by a sudden combustion of the quantity of fuel injected up until the ignition delay time and premixed with combustion air in the process.

This first combustion phase is represented in FIG. 2 as combustion profile BV1, which is shown as a dot-dash line. It starts at the first interpolation point B1, which is separated on the x-axis from the first interpolation point E1 of the equivalent injection profile and thus from the injection start by the ignition delay time Δt_{zv}. The basis for this is the observation that, after the start of injection into the fuel chamber, the fuel needs a certain amount of time, for chemically related reasons, to ignite and burn. This is the reason for the ignition delay time Δt_{zv}. During this period of time, injection continues, and a certain mass of fuel m_{K,p} is injected and mixed with air. This fuel mass is shown as the shaded area under the equivalent injection profile EV between the interpolation points E1 and B1 and is thus obtained by integration of the equivalent injection profile EV between the points E1, B1 according to the following equation:

$${m}_{K , p} = {\int }_{E 1}^{ B 1} EV ( ϕ ) d ϕ = {\int }_{E 1}^{B 1} {\dot{m}}_{K} ( t ) d t , \qquad ( 1 )$$

with the following fuel mass injected per unit time:

$${\dot{m}}_{K} ( t ) = \frac{d}{d t} {m}_{K} ( t ) .$$

The phenomenon that this fuel mass m_{K,p} injected into the fuel chamber and mixed with combustion air during the ignition delay time Δt_{zv} burns almost instantaneously after ignition at the ignition time indicated by the interpolation point B1 is referred to as premixed combustion. This is described by the dot-dash lines of the combustion profile BV1, which is approximately triangular and whose left flank connects the first interpolation point B1 with the second interpolation point B2. The position of the interpolation point B2 is thus determined by the premixed combustion, such that it is obtained especially from equation (1) in connection with the condition formulated in equation (2) below. The quantity of heat Qₚ released during the premixed combustion appears as the area under the combustion profile BV1, i.e., the area under the dot-dash line in FIG. 2, which extends from the first interpolation point B1 to the second interpolation point B2 and then to the third interpolation point B3″. It is thus obtained, for one thing, as the integral of the combustion profile BV1 over the duration of the premixed combustion and thus over the interval Δtₚₘ (specified in °KW). For another, the quantity of heat Qₚ released during the premixed combustion is also obtained as the product of the heat value Hᵤ of the fuel and the fuel mass m_{K,p} injected during the ignition delay time Δt_{zv}. From this we arrive at equation (2):

$${Q}_{p} = {H}_{u} \cdot {m}_{K , p} = {\int }_{B 1}^{B {3}^{″}} BV 1 ( ϕ ) d ϕ = {\int }_{B 1}^{B {3}^{″}} {\dot{Q}}_{p} ( t ) d t , \qquad ( 2 )$$

with the following quantity of heat released during the premixed combustion per unit time:

$${\dot{Q}}_{p} ( t ) = \frac{d}{d t} {Q}_{p} ( t ) .$$

Since the position of the first interpolation point B1 for the combustion profile is already predetermined by the ignition delay time Δt_{zv}, and the position of the end point B3″ of the premixed combustion can be computed from the duration of the premixed combustion Δtₚₘ when the fuel mass m_{K,p} injected during the ignition delay time Δt_{zv} and the corresponding reaction rates are known, the position of the second interpolation point B2 can be uniquely determined with the aid of equations (1) and (2), in particular, when it is demanded that the combustion profile BV1 of the premixed combustion is symmetrically formed with respect to a reflection plane arranged centrally between the points B1 and B3″ and that the second interpolation point B2 thus lies on the center line between the interpolation points B1, B3″. All together, the position of the second interpolation point B2 is thus obtained preferably from the assumption of a symmetrical triangular shape for the combustion profile BV1 of the premixed combustion and from equations (1) and (2).

A second combustion phase, which overlaps the phase of premixed combustion, is called diffusion combustion and is described in FIG. 2 by the broken line that represents combustion profile BV2. The basic assumption of diffusion combustion is based on the fact that the fuel injected during the injection period after the ignition delay time Δt_{zv} has ended is not sufficiently mixed with combustion air for ignition to occur. Mixing with combustion air occurs essentially by diffusion, so that the time represented in FIG. 2 by the interpolation point B3′, at which the diffusion combustion begins, is shifted from the time of ignition, which is represented in FIG. 2 by the interpolation point B1, by a time interval Δt_{D}, which is determined by a diffusion constant of the fuel in the combustion air. It is further assumed that the reaction rate of the fuel once it has been ignited is very much faster than the diffusion determined by the characteristic diffusion time Δt_{D}, so that the reaction is completely controlled by diffusion. The position of the second interpolation point B4 of the combustion profile BV2 for the diffusion combustion is thus obtained from the course of the equivalent injection profile EV from its intersection with a straight line parallel to the y-axis at the interpolation point B1 to its second interpolation point E2, taking into consideration the characteristic diffusion time Δt_{D}.

The position of the third interpolation point B5 of the combustion profile BV2 for the diffusion combustion is obtained essentially from the course of the equivalent injection profile EV between the interpolation points E2, E3. In particular, the position of the interpolation point B5 is correlated with the end of the plateau of the injection profile EV at the interpolation point E3, taking into consideration the characteristic diffusion time Δt_{D}.

In this regard, the interpolation point E3 of the equivalent injection profile represents the time at which an injector injecting the fuel begins its closing stroke. Since this requires a finite interval of time, fuel continues to be introduced into the fuel chamber until the actual end of injection occurs at interpolation point E4.

The fuel still unreacted after injection has ended burns in a burnout phase, which is described by the hyperbola connecting the interpolation points B5, B6. The parameter b and the position of the interpolation point B6 are thus essentially determined by this burnout phase.

The following are additional conditions for the position of the interpolation points B4, B5 and B6 and the additional parameter b: For the diffusion combustion, a fuel mass m_{K,D} is available, which is obtained as the area under the injection profile EV from the interpolation point B1 to the actual end of injection given by the interpolation point E4 and thus as the integral of the equivalent injection profile EV between these points, i.e., according to equation (3) below:

$${m}_{K , D} = {\int }_{B 1}^{E 4} EV ( ϕ ) d ϕ = {\int }_{B 1}^{E 4} {\dot{m}}_{K} ( t ) d t . \qquad ( 3 )$$

The quantity of heat Q_{D} released during the diffusion combustion is now obtained, on the one hand, as the product of the heat value of the fuel and the fuel mass m_{K,D} available for the diffusion combustion and, on the other hand, as the area under the combustion profile BV2 for the diffusion combustion and thus as the integral over the combustion profile BV2 from the interpolation point B3″ to the interpolation point B6. All together, this results in the following equation:

$${Q}_{D} = {\int }_{B {3}^{′}}^{B 6} B V 2 ( ϕ ) d ϕ = {\int }_{B {3}^{′}}^{B 6} {\dot{Q}}_{D} ( t ) d t , \qquad ( 4 )$$

with the following quantity of heat released during the diffusion combustion per unit time:

$${\dot{Q}}_{D} ( t ) = \frac{d}{d t} {Q}_{D} ( t ) .$$

All together, therefore, the combustion profile BV2 for the diffusion combustion can be computed from the equivalent injection profile EV on the basis of the relationships described above and under the conditions of equations (3) and (4).

The total combustion profile BV is now obtained from a superposition or sum of the combustion profile BV1 for the premixed combustion and the combustion profile BV2 for the diffusion combustion. The third interpolation point B3 of the equivalent combustion profile is thus given especially by the positions of the interpolation points B3′, B3″ and of the linear connections between the interpolation points B2 and B3″, on the one hand, and B3′ and B4, on the other hand.

It is found that in an especially simple embodiment of the method, both the equivalent injection profile and the equivalent combustion profile are described by interpolation points that are essentially linearly connected with each other. In other embodiments of the method, it is possible to replace at least one such linear path between two interpolation points by a predetermined weighted and/or rounded function. It is also possible to weight at least one linear connection between two interpolation points by a predetermined function. This makes it possible to obtain an even more accurate description of the actual injection profile and/or the actual combustion profile without this resulting in an excessive increase in the requirements for memory and computing power, because it results in only a small number of additional parameters that it may be necessary to compute. In particular, it is also possible to describe the equivalent injection profile and/or the equivalent combustion profile by a predetermined, weighted and/or rounded function that passes through the given interpolation points.

It is also found that the above-described derivation of the equivalent combustion profile BV from the equivalent injection profile EV is essentially based on the assumption of proportionality between the injection profile and the combustion profile. In one embodiment of the method, however, it is possible to refine this assumption by weighting the assumed proportionality with a predetermined function. In this way, it is possible, without a significant increase in the requirements for memory and computing power, to obtain an even more accurate description of the actual processes, especially of the actual injection profile and/or the actual combustion profile.

All together, it is found that the method makes it possible, with low computing time, low memory capacity and low computing power, to compute an equivalent combustion profile BV from an equivalent injection profile EV and only a few engine characteristics. In this regard, simplification is realized and memory space is saved, and it is basically found that both the equivalent injection profile EV and the equivalent combustion profile BV are described by only a few interpolation points, preferably four and six interpolation points, respectively, and, if necessary, by a few additional parameters, preferably one additional parameter, by using a basic assumption about both a first curve form for the equivalent injection profile EV and a second curve form for the equivalent combustion profile BV. The relationships between engine characteristics that are used in the computation of the equivalent injection profile EV and the resulting equivalent injection profile EV are relatively simple and understandable. Furthermore, the equivalent combustion profile BV is obtained from the equivalent injection profile EV with the aid of additional engine characteristics by means of relatively simple relationships. All together then, modeling is obtained that is not only mathematically very simple and quickly and easily computed but also physically understandable. Additional engine characteristics can in turn be computed from the equivalent combustion profile BV. The fundamental characteristics of measured combustion profiles are exactly reproduced by the equivalent combustion profile BV computed by means of the method. Rapid and simple computation of the equivalent combustion profile BV and, if necessary, at least one additional engine characteristic is possible especially in the controller software of an engine control unit. In this connection, the fundamental engine characteristics that are needed for the computation can be read directly from the engine control unit without the need for any other measures. Accordingly, an engine control unit suitable for carrying out the method is also preferred, and a computer program product is preferred, by which the method can be carried out when the program is realized on a computer, especially on a computer of an engine control unit.

1-13. (canceled)

14. A method for computing engine characteristics of an internal combustion engine, comprising the steps of: determining an equivalent injection profile in a first curve form described by interpolation points, such that the interpolation points are computed from at least one first engine characteristic; and determining an equivalent combustion profile in a second curve form described by interpolation points, such that at least one interpolation point is computed from the equivalent injection profile and at least one second engine characteristic.

15. The method in accordance with claim 14, wherein a trapezoidal shape is assumed for the equivalent injection profile, with at most ten interpolation points, where in each case a predetermined functional plot between the interpolation points is assumed.

16. The method in accordance with claim 15, wherein the trapezoidal shape has at most eight interpolation points.

17. The method in accordance with claim 16, wherein the trapezoidal shape has at most six interpolation points.

18. The method in accordance with claim 17, wherein the trapezoidal shape has exactly four interpolation points.

19. The method in accordance with claim 15, wherein the functional plot is a linear plot and/or a plot weighted and/or rounded with at least one predetermined function.

20. The method in accordance with claim 14, wherein the equivalent combustion profile is described by at most twelve interpolation points and by a predetermined functional plot between the interpolation points.

21. The method in accordance with claim 20, wherein the equivalent combustion profile is described by at most ten interpolation points.

22. The method in accordance with claim 21, wherein the equivalent combustion profile is described by at most eight interpolation points.

23. The method in accordance with claim 22, wherein the equivalent combustion profile is described by exactly six interpolation points.

24. The method in accordance with claim 20, wherein the second curve form is assumed to follow a polygonal path which connects the interpolation points, with the exception of a last interpolation point with a highest abscissa value, which is weighted and/or rounded with at least one predetermined function, and which is followed by a hyperbola that connects a last two interpolation points.

25. The method in accordance with claim 14, wherein the at least one first engine characteristic is selected from a group consisting of: an engine speed, an injection start, an injection time, an injected fuel quantity, a fuel temperature, a fuel density, an injection pressure, a cylinder internal pressure at a time of injection start, and a compression ratio.

26. The method in accordance with claim 14, wherein the at least one second engine characteristic is selected from a group consisting of: an ignition delay time, an opening time of an exhaust valve of a cylinder, an engine speed, a charge motion within the cylinder, an exhaust gas return rate, a piston shape, and an injection parameter.

27. The method in accordance with claim 26, wherein the change motion is a spin.

28. The method in accordance with claim 14, including computing at least one additional engine characteristic from the equivalent combustion profile.

29. The method in accordance with claim 28, wherein the at least one additional engine characteristic is selected from a group that consists of a cumulative combustion profile, a cylinder pressure as a function of a crank angle, a mean indicated pressure, an emission value, an efficiency and an output of the internal combustion engine.

30. The method in accordance with claim 28, including using the equivalent combustion profile determined for an internal combustion engine and/or the at least one additional engine characteristic to control an operating state of the internal combustion engine.

31. The method in accordance with claim 28, including computing a change in the equivalent combustion profile and/or the additional engine characteristic when a change occurs in a selected engine characteristic, such that the change predicted in this way is evaluated, and the selected engine characteristic is either changed or held constant based on this evaluation.

32. The method in accordance with claim 31, wherein a plurality of changes in the selected engine characteristic are evaluated with respect to resulting changes in the equivalent combustion profile and/or the additional engine characteristic, where the selected engine characteristic is either changed or held constant based on the evaluations, and/or the method is carried out iteratively, such that the method is used for automatically controlling an engine characteristic during operation of the internal combustion engine.

33. The method in accordance with claim 14, wherein the equivalent injection profile and/or the equivalent combustion profile is determined for at least one operating point in an input-output map of the internal combustion engine, where the equivalent combustion profile is converted for other operating points of the input-output map by the equivalent injection profile.

34. The method in accordance with claim 14, wherein the method is carried out in an engine control unit.

35. A data processing system designed for computing engine characteristics, wherein the data processing system is an engine control unit operative to carry out the method according to claim 14.

36. A computer program product with program code means that are stored on a computer-readable data carrier for carrying out the method according to claim 14.

37. The computer program product according to claim 36, wherein the data carrier is a microchip of an engine control unit
